(19) United States
(12) Patent Application Publication
(10) Pub. No.: US 2015/0189121 A1
(43) Pub. Date: Jul. 2, 2015

(54) IMAGE READING DEVICE, IMAGE READING METHOD AND PROGRAM THEREOF

(71) Applicant: Mitsuo SHINYA, Ohta-ku (JP)

(72) Inventor: Mitsuo SHINYA, Ohta-ku (JP)

(73) Assignee: RICOH COMPANY, LTD., Tokyo (JP)

(21) Appl. No.: 14/558,843

(22) Filed: Dec. 3, 2014

(30) Foreign Application Priority Data
Dec. 27, 2013 (JP) 2013-272519

(51) Int. Cl. H04N 1/32; H04N 1/00

(52) U.S. Cl. CPC H04N 1/32448; H04N 1/00095; H04N 1/32374; H04N 1/32384; H04N 2201/0094; H04N 2201/214; H04N 2201/3298

(57) ABSTRACT

An image reading device includes an arbitration unit; a first transmission/reception unit that receives read image data and transfers the image data to the arbitration unit; a second transmission/reception unit that receives the image data from the arbitration unit and transfers the image data to a first storage unit; a detection unit that detects that a used amount of a buffer of the second transmission/reception unit exceeds a threshold; and an instruction unit that instructs changing a destination of image data, which are to be transferred from the first transmission/reception unit, to a second storage unit which is connected to the arbitration unit in response to a detection by the detection unit that the used amount of the buffer exceeds the threshold.

### BACKGROUND OF THE INVENTION

1. Field of the Invention

The disclosures herein generally relate to an image reading device, an image reading method and a program thereof.

2. Description of the Related Art

Conventionally, in the case of reading a document at an MFP (Multifunction peripheral), a controller ASIC (Application Specific Integrated Circuit) receives image data from an image processing ASIC to which a scanner is connected. The image data are stored in a main memory via a chipset. However, there is a problem that in transferring the image data having a large size, a latency of the main memory may change significantly, and a bandwidth of a transmission path on the chipset side may become insufficient for transferring the image data read by the scanner. As a result, a part of the image data transferred from the controller ASIC side may be lost, i.e. the image data are destroyed.

Japanese Published Patent Application No. 2008-301186 discloses an image forming apparatus that divides read data into plural pieces and compresses each of the pieces, so that an amount of memory required for storing the read data is reduced, thereby the destruction of the image data can be prevented.

### SUMMARY OF THE INVENTION

It is a general object of at least one embodiment of the present invention to provide an image reading device, an image reading method and a program thereof that substantially obviate one or more problems caused by the limitations and disadvantages of the related art.

In one embodiment, an image reading device includes an arbitration unit; a first transmission/reception unit that receives read image data and transfers the image data to the arbitration unit; a second transmission/reception unit that receives the image data from the arbitration unit and transfers the image data to a first storage unit; a detection unit that detects that a used amount of a buffer of the second transmission/reception unit exceeds a threshold; and an instruction unit that sends an instruction to change a destination of image data, which are to be transferred from the first transmission/reception unit, to a second storage unit which is connected to the arbitration unit in response to a detection by the detection unit that the used amount of the buffer exceeds the threshold.

In another embodiment, an image reading method includes receiving read image data by a first transmission/reception unit; transferring the image data received by the first transmission/reception unit to an arbitration unit; receiving the image data by a second transmission/reception unit from the arbitration unit; transferring the image data received by the second transmission/reception unit to a first storage unit; detecting that a used amount of a buffer of the second transmission/reception unit exceeds a threshold; and sending an instruction to change a destination of image data, which are to be transferred from the first transmission/reception unit, to a second storage unit which is connected to the arbitration unit in response to a detection that the used amount of the buffer exceeds the threshold.

In yet another embodiment, a non-transitory computer-readable storage medium stores a program for causing a computer to execute an image reading method. The image reading method includes a step of receiving read image data by a first transmission/reception unit; a step of transferring the image data received by the first transmission/reception unit to an arbitration unit; a step of receiving the image data by a second transmission/reception unit from the arbitration unit; a step of transferring the image data received by the second transmission/reception unit to a first storage unit; a step of detecting that a used amount of a buffer of the second transmission/reception unit exceeds a threshold; and a step of sending an instruction to change a destination of image data, which are to be transferred from the first transmission/reception unit, to a second storage unit which is connected to the arbitration unit in response to a detection that the used amount of the buffer exceeds the threshold.

According to the present embodiment, there are provided an image reading device, an image reading method and a program that can process image data read from a document efficiently while destruction of the image data is prevented.

### BRIEF DESCRIPTION OF THE DRAWINGS

Other objects and further features of embodiments will be apparent from the following detailed description when read in conjunction with the accompanying drawings, in which:

FIG. 1 is a diagram illustrating an example of a configuration of an image reading device according to a present embodiment;

FIG. 2 is a diagram illustrating an example of a configuration of a controller ASIC according to the present embodiment;

FIG. 3 is an explanatory diagram illustrating an example of a process in the image reading device according to the present embodiment;

FIG. 4 is an explanatory diagram illustrating another example of the process in the image reading device according to the present embodiment;

FIG. 5 is a diagram illustrating an example of a configuration of a descriptor according to the present embodiment;

FIG. 6 is a functional block diagram illustrating an example of the image reading device according to the present embodiment;

FIG. 7 is a flowchart illustrating an example of a procedure of processes of the image reading device according to the present embodiment;

FIG. 8 is a sequence diagram illustrating an example of an operation of the image reading device according to the present embodiment;

FIG. 9 is an explanatory diagram illustrating yet another example of the process in the image reading device according to the present embodiment;

FIG. 10 is an explanatory diagram illustrating another example of the process in the image reading device according to the present embodiment;

FIG. 11 is a functional block diagram illustrating another example of the image reading device according to the present embodiment;

FIG. 12 is a flowchart illustrating another example of a procedure of processes of the image reading device according to the present embodiment; and

FIG. 13 is a sequence diagram illustrating another example of an operation of the image reading device according to the present embodiment.

### DESCRIPTION OF THE PREFERRED EMBODIMENTS

In the following, embodiments of the present invention will be described with reference to the accompanying drawings.

### First Embodiment

### <1. Outline of Embodiment>

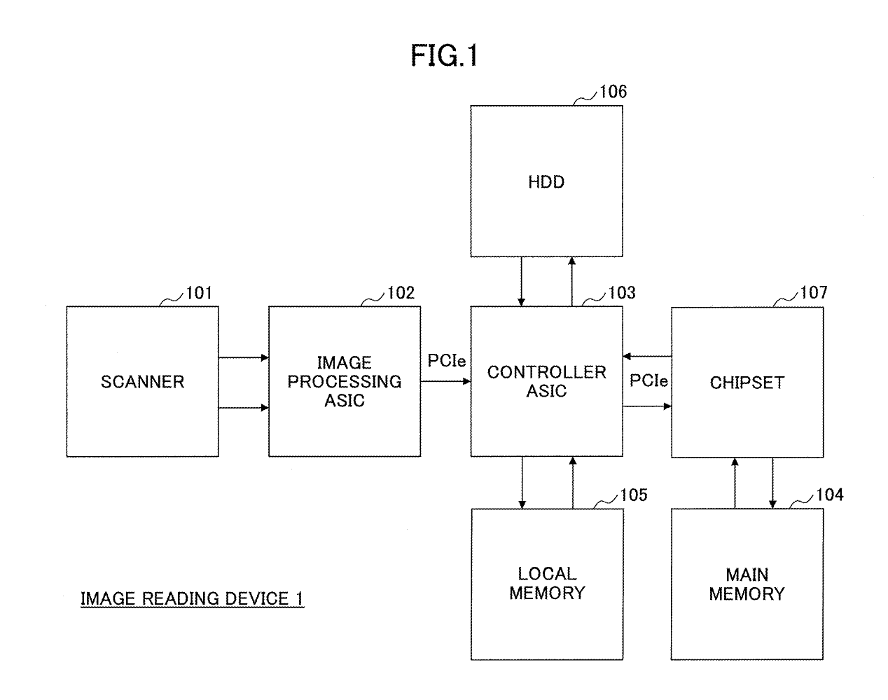

FIG. 1 is a diagram illustrating an example of a configuration of the image reading device 1 according to an embodiment of the present invention. FIG. 1 only shows a main part of the image reading device 1. The image reading device 1 includes a scanner 101, an image processing ASIC 102, a controller ASIC 103, a main memory 104, a local memory 105, a HDD (Hard Disk Drive) 106 and a chipset 107.

The scanner 101 reads a side or both sides of a document and transfers acquired image data. In the case of reading both sides of the document, data from the front side and data from the rear side can be transferred simultaneously. The image processing ASIC 102 performs image processing and compression processing for the image data read by the scanner 101. The controller ASIC 103 arbitrates communications between the image processing ASIC 102 and the chipset 107 and communications between the chipset 107 and the HDD 106. The controller ASIC 103 includes an arbiter inside it.

The main memory 104 accumulates the read image data. The main memory 104 has a bandwidth of about 700 MB/s and operates with a latency of about 1 μs. In the same way, the local memory 105 can accumulate image data instead of the main memory 104 when the bandwidth of the main memory 104 becomes insufficient.

The local memory 105 has, for example, a bandwidth of about 2 GB/s and operates with a latency of about 200 ns. The local memory 105 is normally used by an image drawing module installed in the controller ASIC 103. Since the image drawing module executes a lot of read-modify-write processes (a series of processes of reading data at specified address/data, processing the data and writing data into the original address/port), the local memory 105 having a low latency is used.

The HDD 106 finally stores the image data retained in the main memory 104 and the local memory 105. Moreover, the HDD 106 is used as a program area or as a swap area for a CPU (Central Processing Unit) connected to the chipset 107.

The chipset 107 includes the CPU inside it, and is connected to the main memory 104. The chipset 107 may further include an interface for connecting an HDD or a USB (Universal Serial Bus) interface.

The image data read by the scanner 101 are, for example, treated with shading at the image processing ASIC 102. Afterwards, the image data are transferred from the image processing ASIC 102 to the controller 103 through a PCIe (PCI Express) (Trademark registered) interface. The image data are further transferred to the chipset 107 through the PCIe interface. The image data are finally transferred to the main memory 104, and the reading procedure ends.

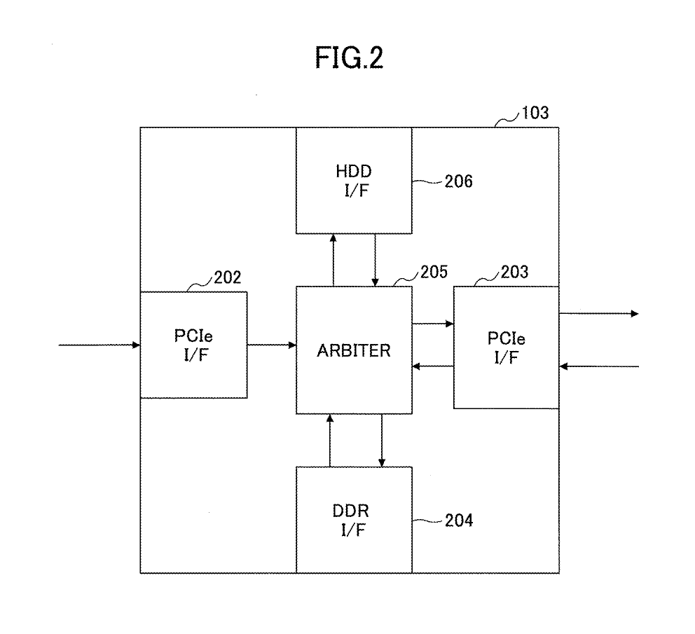

FIG. 2 is a diagram illustrating a configuration of the controller ASIC 103 which is shown in FIG. 1. The controller ASIC 103 includes PCIe interfaces (I/Fs) 202, 203, a DDR (Double-Data-Rate) interface 204, an arbiter 205 and an HDD interface (I/F) 206.

As exemplified in FIG. 2, the arbiter 205 that arbitrates data input from the side of the scanner 101 and data input from the side of the chipset 107 is connected to the image processing ASIC 102 via the PCIe interface 202. Moreover, the arbiter 205 is connected to the chipset 107 via the PCIe interface 203.

Moreover, the arbiter 205 is connected to the local memory 105 via the DDR interface 204. Furthermore, the arbiter 205 transfers the image data retained in the main memory 104 or in the local memory 105 to the HDD via the HDD interface 206.

In the following, as shown in FIG. 1 or FIG. 2, an example where the arbiter 205 is connected to the local memory 105 via the DDR interface 204 will be explained. However, the present invention is not limited to this example. The arbiter 205 and the local memory 105 may be connected to each other, for example, via a NAND memory interface or an SPI (Serial Peripheral Interface).

Moreover, in the following, an example where the local memory 105 is a DDR memory will be explained. However, the present invention is not limited to this example. For example, a storage device connected via a SD card or the network may be used instead of the local memory.

Moreover, in the following, an example where the controller ASIC 103 is connected to the image processing ASIC 102 via the PCIe interface and the controller ASIC 103 is connected to the chipset 107 via the PCIe interface will be explained. However, the present invention is not limited to this. A serial bus or a parallel bus may be arbitrarily used.

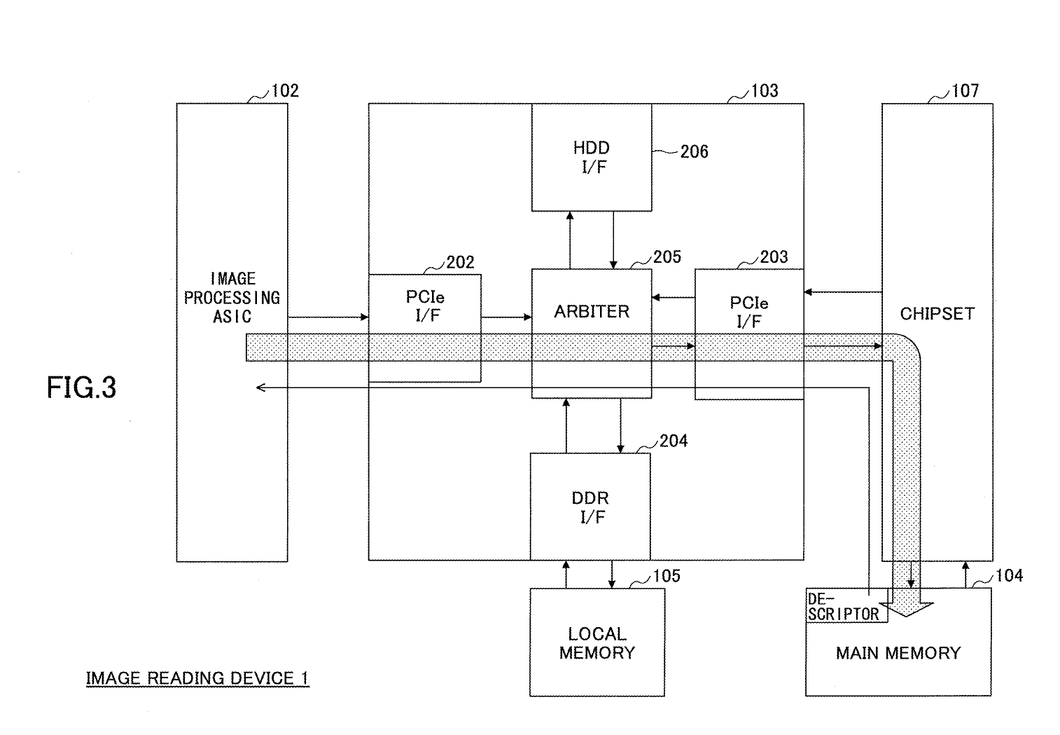

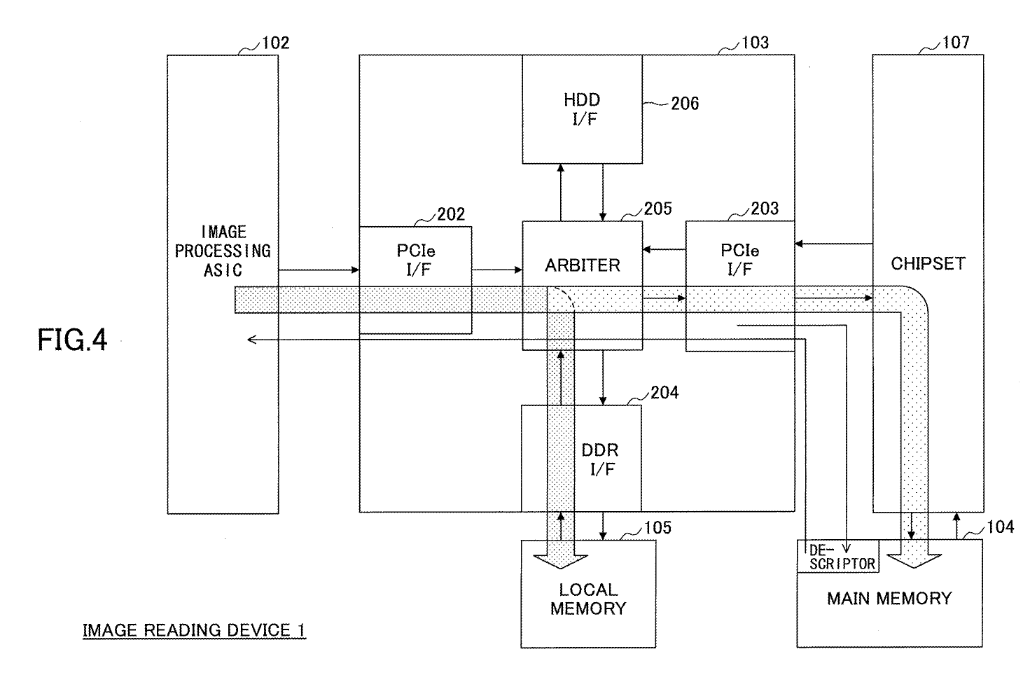

Next, with reference to FIGS. 3 and 4, a flow of the read image data will be explained. FIGS. 3 and 4 illustrate examples of the configuration of the image reading device 1 according to the present embodiment, and include the respective elements shown in FIGS. 1 and 2. Meanwhile, in each of FIGS. 3 and 4, a descriptor stored in the main memory 104 is shown.

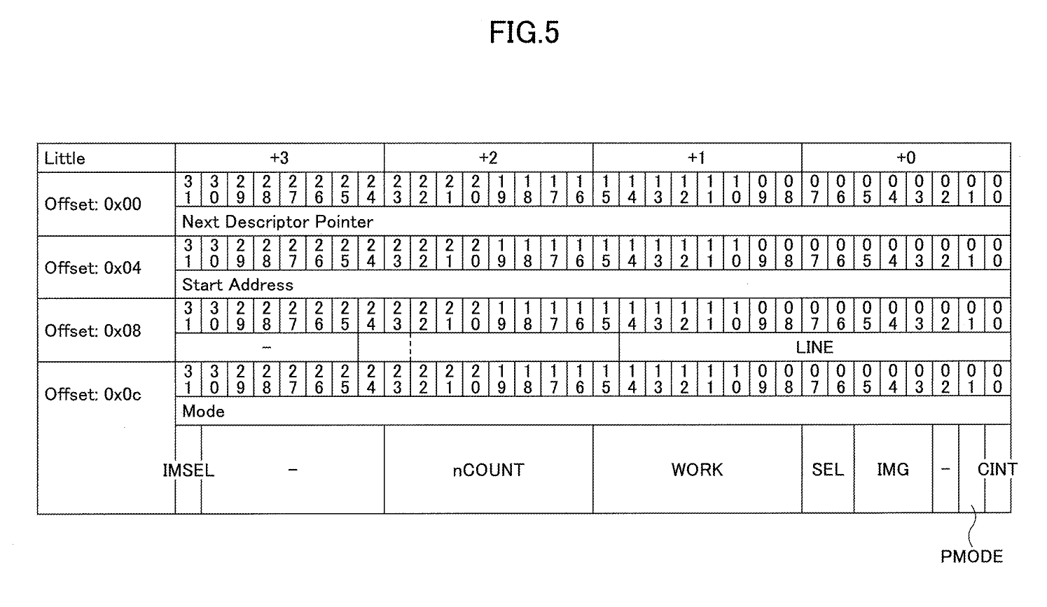

FIG. 5 illustrates an example of a configuration of the descriptor which describes a configuration, content, attribute or the like of the read image data. The descriptor may be provided for each page of the read image data. In the present embodiment, a descriptor having an arbitrary configuration may be used. However, in the present embodiment, the descriptor includes an area “IMSEL” indicating whether the read image data are retained in the local memory 105.

FIG. 3 illustrates the image data, which are read by the scanner 101 and stored in the main memory 104 through the controller ASIC 103. First, the image processing ASIC 102, as a master, reads the descriptor in the main memory 104, acquires an amount of transfer and a destination address of transfer, and transfers the image data to the main memory 104.

Afterwards, the image data are stored in the main memory 104 through the PCIe I/F 202, the arbiter 205 and the PCIe I/F 203.

Here, the PCIe I/Fs 202, 203 are packet-type serial interfaces. Therefore, according to a CPU cache flash operation for the main memory 104 from the CPU or transfer processing to the controller ASIC 103 from the CPU, the latency of the transfer path may be degraded and the bandwidth may become insufficient. When the bandwidth becomes insufficient for transferring the image data while the image data are being transferred to the main memory 104, the image data may be destroyed along the way.

FIG. 4 illustrates the image data, which is read by the scanner 101 and stored in the local memory 105 through the controller ASIC 103.

The PCIe I/F 203 according to the present embodiment can monitor a used amount of write buffer in the chipset 107. When the used amount exceeds a predetermined threshold, the PCIe I/F 203 determines that a sufficient bandwidth is not ensured because of a change in the latency and switches the destination address of the transaction which has been from the image processing ASIC 102 to the main memory 104.

The used amount of the buffer may also increase by, for example, an occurrence of an “Unsupported Correction” error at the PCIe I/F 203.

The PCIe I/F 203 gives notice of the switching of the address to the PCIe I/F 202 on the side of the image processing ASIC 102. According to this notice, the destination address of transfer of the image data transferred from the image processing ASIC 102 is switched to the local memory 105. Meanwhile, in order to give notice of the switching of the address, for example, a notice packet may be transferred from the PCIe I/F 203 to the PCIe I/F 202. Or, a dedicated signal line for notice may be provided between the PCIe I/F 203 and the PCIe I/F 202.

The PCIe I/F 202 on the side of the image processing ASIC 102 monitors image lines in the read image data. The PCIe I/F 202 switches an address to be output to the arbiter 205 at a break of the image lines according to the notice from the PCIe I/F 203. For example, the switching of address is determined by an ID issued by the master (for example, an axi_id signal in the case of the AXI I/F). Here, the switching of address is determined only for the transaction from the image processing ASIC 102, but the address for the transaction from the other master is not switched.

According to the above-described operation, the image lines in the image data after the notice is received are stored in the local memory 105. Here, a number of the image lines (hereinafter referred to as line number) of the image data retained in the local memory 105 are stored in a register of the PCIe I/F 202. The PCIe I/F 203 monitors the number of lines stored in the local memory 105. When transfer of an amount of one page of the image data is performed, the “IMSEL” bit in the descriptor is changed and an accumulation of the image data in the local memory 105 is recorded.

According to the above-described processes, it is detected that the bandwidth of the data transfer path to the main memory 104 becomes insufficient and a part of the image data is stored in the local memory 105, thereby destruction of the image data can be prevented.

Meanwhile, when the transferred image data reach the amount of two pages, a versatile DMAC (Direct Memory Access Controller) of the controller ASIC 103 may transfer the image data accumulated in the local memory 105 to the main memory 104.

### <2. Function of Image Reading Device>

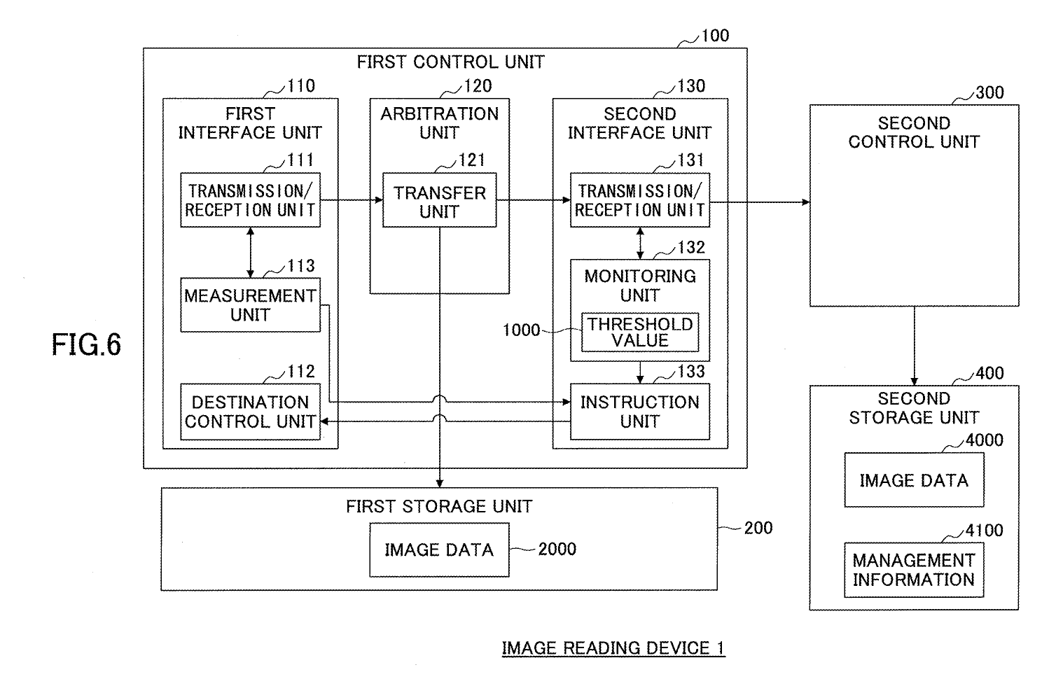

With reference to FIG. 6, a function of the image reading device 1 according to the present embodiment will be explained. The image reading device 1 includes a first control unit 100, a first storage unit 200, a second control unit 300 and a second storage unit 400. The first control unit 100 is realized by the controller ASIC 103 in FIG. 1, and the first storage unit 200 is realized by the local memory 105 in FIG. 1. Moreover, the second control unit 300 is realized by the chipset 107 in FIG. 1, and the second storage unit 400 is realized by the main memory 104 in FIG. 1.

The first control unit 100 includes a first interface unit 110, an arbitration unit 120 and a second interface unit 130. The first interface unit 110 is realized by the PCIe I/F 202 in FIG. 2, the arbitration unit 120 is realized by the arbiter 205 in FIG. 2 and the second interface unit 130 is realized by the PCIe I/F 203 in FIG. 2.

The first interface unit 110 includes a transmission/reception unit 111, a destination control unit 112 and a measurement unit 113.

The transmission/reception unit 111 receives image data that are read by the scanner 101 in FIG. 1 and are processed by the image processing ASIC 102, and transmits the image data to a destination indicated by the destination control unit 112.

The destination control unit 112 controls the destination of the image data that the transmission/reception unit transmits. The destination control unit 112 upon receiving an instruction signal, which will be described later, from an instruction unit 133 of the second interface unit 130 switches the destination of the image data to the second storage unit 400 or the first storage unit 200.

The measurement unit 113 measures a data amount of the image data that the transmission/reception unit 111 transmits.

The arbitration unit 120 includes a transfer unit 121, and arbitrates data transmission which is performed through the first control unit 100.

The transfer unit 121 transfers the image data received from the transmission/reception unit 111 to the second interface unit 130 or the first storage unit 200. Moreover, the transfer unit 121 transfers image data retained in the first storage unit 200 to the second storage unit 400 according to an instruction from the second control unit 300.

The second interface unit 130 includes a transmission/reception unit 131, a monitoring unit 132 and an instruction unit 133.

The transmission/reception unit 131 accumulates the image data received from the transfer unit 121 in a buffer, and transmits the image data to the second control unit 300. The buffer has, for example, a capacity of about 16 lines in units of one line in the image data. However, the unit and the capacity of the buffer may be set arbitrarily.

The monitoring unit 132 monitors a used amount of the buffer of the transmission/reception unit 131. When the used amount of the buffer exceeds a predetermined threshold 1000, transmits a notice signal to the instruction unit 133. For the threshold 1000, for example, 14 lines are set when the buffer capacity is 16 lines. The threshold 1000 may be an arbitrary value that can be changed. Moreover, the threshold 1000 can be stored arbitrarily in a storage area of any of the monitoring unit 132, the second interface unit 130, the first storage unit 200 and the like.

The instruction unit 133 upon receiving the notice signal from the monitoring unit 132 transmits an instruction signal to switch the destination of the image data from the second storage unit 400 to the first storage unit 200 to the destination control unit 112 of the first interface unit 110.

Moreover, the instruction unit 133 can acquire data amounts of the image data transmitted to the second storage unit 400 and the first storage unit 200, respectively. In the case where the image data are transmitted to the first storage unit 200, when the data amount of the image data reaches a break of one page of the document, the instruction unit 133 transmits an instruction signal to switch the destination of the image data from the first storage unit 200 to the second storage unit 400 to the destination control unit 112. The instruction unit 133 may transmit the above-described instruction signal when an amount of the transmitted data reaches a data quantity predetermined arbitrarily (for example, a predetermined number of pages (arbitrary integer), a predetermined number of lines, a predetermined number of bytes, or the like). Furthermore, the instruction unit may transmit the above-described instruction signal when the used amount of the buffer of the transmission/reception unit 131 becomes lower than another threshold which is less than the predetermined threshold 1000.

Moreover, in the case where the image data are transmitted to the first storage unit 200, when the data amount of the image data reaches a break of one page of the document, the instruction unit 133 updates the descriptor (management information 4100) of the image data stored in the second storage unit 400. Specifically, the instruction unit 133 validates the “IMSEL” bit in the descriptor exemplified in FIG. 5, and records that the image data are retained not only in the second storage unit 400 but also in the first storage unit 200. Furthermore, the instruction unit 133 can record in the descriptor an address or a data amount of the image data retained in the first storage unit 200.

The first storage unit 200 stores the image data 2000 transmitted from the arbitration unit 120.

The second control unit 300 controls an entire operation of the image reading device 1. The second control unit 300 can cause an application that controls the content of the process of reading a document at the scanner 101 or the content of the imaging process at the image processing ASIC 102 to operate. The second control unit 300, in the operation of reading the document, stores the image data transmitted from the second interface unit 130 (the transmission/reception unit 131) of the first control unit 100 to the second storage unit 400.

The second storage unit 400 stores the image data 4000 received from the second control unit 300 and management information 4100 which is a descriptor of the image data. Meanwhile, the management information 4100 may be provided for each page of the image data.

According to the above-described functions, the image data are stored in the first storage unit 200 and in the second storage unit 400. Afterwards, the second control unit 300 with reference to the management information 4100 detects that a part of image data 2000 is stored in the first storage unit 200, and causes the image data 2000 to merge with the image data 4000 in the second storage unit 400. Or, the second control unit 300 may transfer the image data 4000 in the second storage unit 400 and the image data 2000 in the first storage unit 200 to the HDD 106 via the first control unit 100.

In this way, in the case where image data are stored in the first storage unit 200 and in the second storage unit 400, treatments for the image data stored in the respective storage units depend on the operation of the application in the second control unit 300.

### <3. Example of Operation>

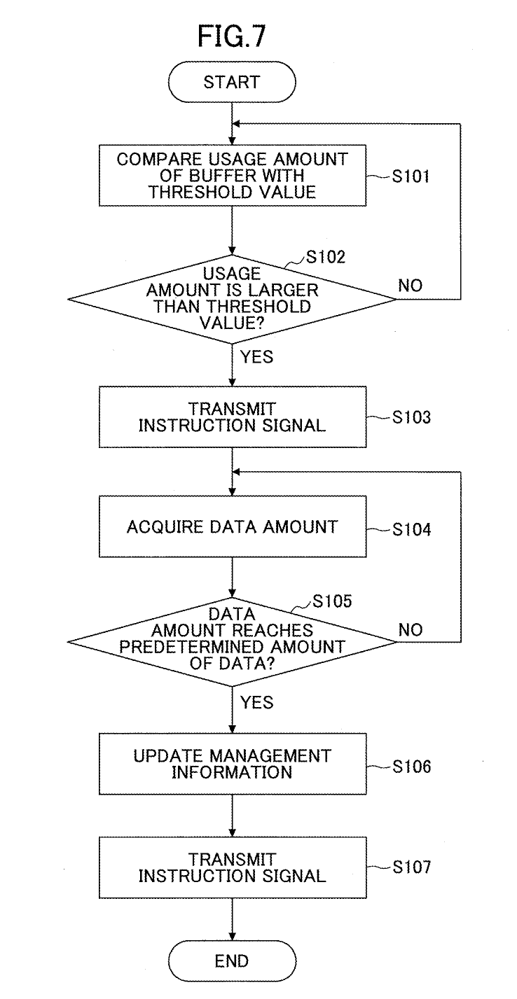

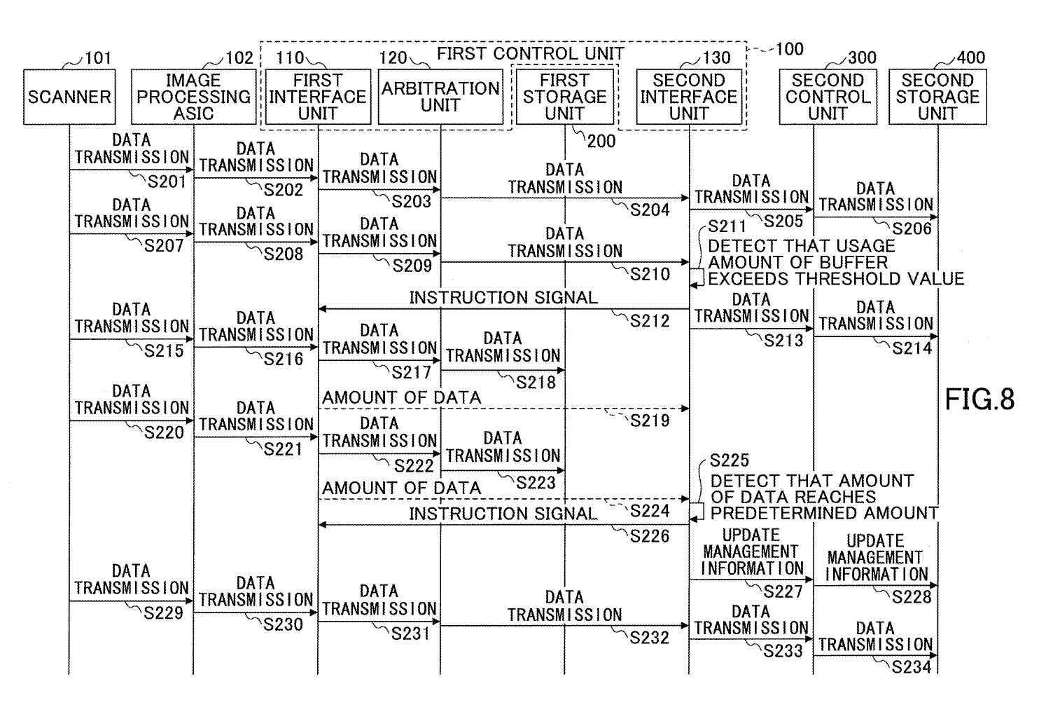

Next, with reference to FIGS. 7 and 8, an example of the operation of the image reading device 1 according to the present embodiment will be explained.

FIG. 7 is a flowchart illustrating a flow of processes of the image reading device 1 according to the present embodiment. Here, it is in a state where the second control unit 300 controls the scanner 101 of the image reading device 1 to read a document, and to transfer the acquired image data to the second storage unit 400 via the first control unit 100.

The monitoring unit 132 of the second interface unit 130 acquires a used amount of a buffer of the transmission/reception unit 131 and compares it with the threshold 1000 (step S101). When the used amount is greater than the threshold 1000 (step S102: YES), the instruction unit 133 transmits an instruction signal to the destination control unit 112 to switch the destination of the image data from the second storage unit 400 to the first storage unit 200 (step S103). Otherwise (step S102: NO), the process returns to step S101.

After step S103, the instruction unit 133 acquires a data quantity of the transmitted image data (step S104) via the measurement unit 113. When the acquired data quantity reaches a predetermined quantity (step S105: YES), the instruction unit 133 updates the management information 4100 stored in the second storage unit 400 (step S106). Otherwise (step S105: NO), the process returns to step S104.

After step S106, the instruction unit 133 transmits an instruction signal to the destination control unit 112 to switch the destination of the image data from the first storage unit 200 to the second storage unit 400 (step S107).

After the above process the second control unit 300, with reference to the management information 4100, detects that a part of the image data 2000 is retained in the first storage unit 200, and causes the image data 2000 to merge with the image data 4000 in the second storage unit 400.

FIG. 8 is a sequence diagram illustrating an example of an operation of the entire image reading device 1 according to the present embodiment. Here, the second control unit 300 instructs the scanner 101 of the image reading device 1 to read a document.

The scanner 101 reads the document, and transmits the acquired image data to the image processing ASIC 102 (step S201). The image processing ASIC 102 performs a predetermined image process for the image data received from the scanner 101, and transmits the image data to the first interface unit 110 of the first control unit 100 (step S202).

The first interface unit 110 (transmission/reception unit 111) receives image data from the image processing ASIC 102, and transmits the image data to the second storage unit 400 which is a destination indicated by the destination control unit 112 (step S203). The arbitration unit 120 (transfer unit 121) transmits the image data received from the first interface unit 110 to the second interface unit 130 (step S204). The second interface unit 130 (transmission/reception unit 131) transmits the image data received from the arbitration unit 120 to the second control unit 300 (step S205). The second control unit 300 transmits the image data received from the second interface unit 130 to the second storage unit 400 (step S206).

Next, in the same way as above-described steps S201 to S204, image data read by the scanner 101 are transmitted to the second interface unit 130 (steps S207 to S210). Here, assume that data transfer becomes impossible due to a communication error in a communication path between the first control unit 100 and the second control unit 300, and the used amount of buffer of the transmission/reception unit 131 of the second interface unit 130 becomes greater than the threshold.

The second interface unit 130 (monitoring unit 132) detects that the used amount of buffer exceeds the threshold (step S211). Then, the second interface unit 130 (instruction unit 133) transmits an instruction signal to the first interface unit 110 (destination control unit 112) to switch a destination of the image data from the second storage unit 400 to the first storage unit 200 (step S212). Afterwards, the second interface unit 130 (transmission/reception unit 131) transmits the image data accumulated in the buffer to the second control unit 300 (step S213). The second control unit 300 transmits the image data received from the second interface unit 130 to the second storage unit 400 (step S214).

The scanner 101 further transmits the acquired image data to the image processing ASIC 102 (step S215). The image processing ASIC 102 performs a predetermined image process for the image data received from the scanner 101, and transmits the image data to the first interface unit 110 of the first control unit 100 (step S216).

Next, the first interface unit 110 (transmission/reception unit 111) receives the image data from the image processing ASIC 102, and transmits the image data to the first storage unit 200 which is a destination indicated by the destination control unit 112 (step S217). The arbitration unit 120 (transfer unit 121) transmits the image data received from the first interface unit 110 to the first storage unit 200 (step S218). The second interface unit 130 (instruction unit 133) receives a data amount of the transmitted image data from the first interface unit 110 (measurement unit 113) (step S219).

Next, in the same way as above-described steps S215 to S219, the image data read by the scanner 101 is transmitted to the first storage unit 200, and an amount of transmitted data is acquired (steps S220 to S224). Here, the second interface unit 130 (instruction unit 133) detects that a data amount of the transmitted image data reaches a predetermined amount (step S225). Then, the second interface unit 130 (instruction unit 133) transmits an instruction signal to the first interface unit 110 (destination control unit 112) to switch the destination of the image data from the first storage unit 200 to the second storage unit 400 (step S228).

Furthermore, the second interface unit 130 (instruction unit 133) transmits a signal to the second control unit 300 to update management information (step S227). The second control unit 300 updates the management information according to the received signal (step S228).

Afterward, in the same way as above-described steps S201 to S206, the image data read by the scanner 101 are transmitted to the second storage unit 400 via the first control unit 100 and the second control unit 300 (step S229 to S234).

According to the above-described operations, even when an error occurs in a communication path on the side of the second control unit 300 (chipset 107), an overflow of the transmission buffer of the second interface unit 130 (PCIe I/F 203) can be prevented. As a result, the image reading device 1 according to the present embodiment can acquire image data read by the scanner 101 without destruction of the data. This feature is especially effective, for example, in the case where the scanner 101 responds to a double-side reading and transmission of image data requires a large bandwidth.

### [Variation]

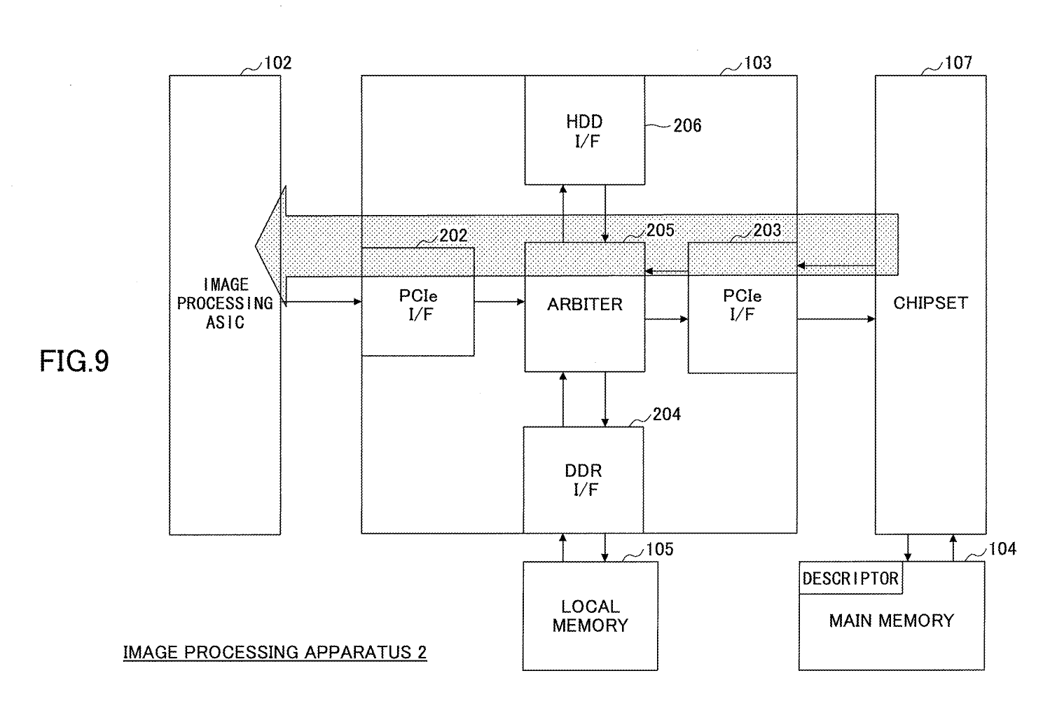

Next, an image processing apparatus 2 according to another embodiment of the present invention will be explained with reference to FIGS. 9 to 13. A configuration of the image processing apparatus 2 according to the present embodiment is the same as the image reading device 1 shown in FIGS. 1 and 2. However, the image processing apparatus 2 includes a plotter (not shown) instead of the scanner 101 shown in FIG. 1. The plotter can output image data input via the image processing ASIC 102 onto a plane of paper. The image processing apparatus 2 outputs image data retained, for example, in the main memory 104 to the plotter via the chipset 107, the controller ASIC 103 and the image processing ASIC 102.

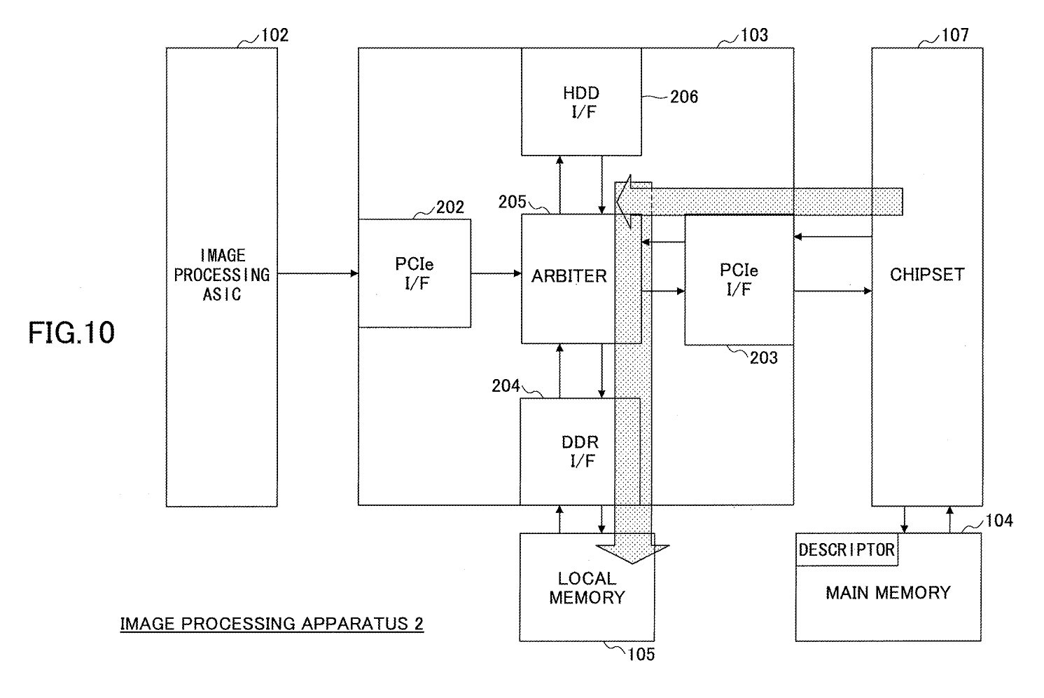

As shown in FIGS. 9 and 10, in the present embodiment, in the case where the image data are transmitted from the chipset 107 to the image processing ASIC 102 when a used amount of a transmission buffer of the PCIe I/F 202 exceeds the threshold, the image data are temporarily accumulated in the local memory 105.

### <Function>

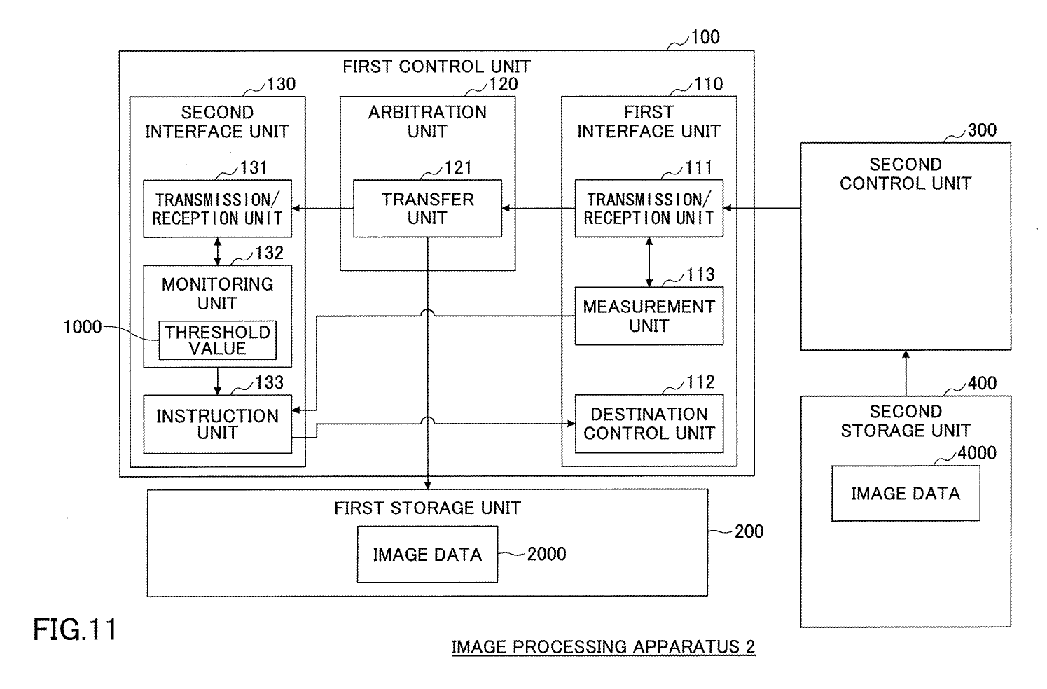

FIG. 11 is a functional block diagram of the image processing apparatus 2 according to the present embodiment. A function of the image processing apparatus 2 is fundamentally the same as that of the image reading device 1 shown in FIG. 6. However, in the example shown in FIG. 11, an application operating in the second control unit 300 transmits the image data stored in the second storage unit 400 or in the HDD 106 to the image processing ASIC 102 via the controller ASIC 103.

As shown in FIG. 11, the first interface unit 110 and the second interface unit 130 are arranged at positions which are opposite to those in the example shown in FIG. 6, respectively. Moreover, the first interface unit 110 receives image data transmitted from the second control unit 300, not from the image processing ASIC 102. Furthermore, the second interface unit 130 transmits the image data to the image processing ASIC 102, not to the second control unit 300.

In the following, an explanation will be provided mainly on a function which is different from the explanation shown in FIG. 6.

The transmission/reception unit 111 in the first interface unit 110, shown in FIG. 11, receives image data transmitted from the second control unit 300, and transmits the image data to a destination indicated by the destination control unit 112.

The destination control unit 112 in the first interface unit 110, shown in FIG. 11, upon receiving an instruction signal from the instruction unit 133 in the second interface unit 130, switches the destination of the image data to the image processing ASIC 102 or to the first storage unit 200.

The transfer unit 121 in the arbitration unit 120, shown in FIG. 11, according to the instruction from the instruction unit 133, transmits the image data temporarily stored in the first storage unit 200 to the image processing ASIC 102.

The transmission/reception unit 131 in the second interface unit 130, shown in FIG. 11, accumulates the image data received from the transfer unit 121 in a buffer, and transmits the image data to the image processing ASIC 102.

The instruction unit 133 in the second interface unit 130, shown in FIG. 11, upon receiving a notification signal from the monitoring unit 132, transmits an instruction signal to the destination control unit 112 to switch the destination of the image data from the image processing ASIC 102 to the first storage unit 200.

Moreover, in the case where data are transmitted to the first storage unit 200 when the data amount of the data reaches a predetermined data amount, the instruction unit 133 instructs the transfer unit 121 to transmit the image data stored in the first storage unit 200 to the image processing ASIC 102. Afterwards, the instruction unit 133 transmits an instruction signal to the destination control unit 112 to switch the destination of the image data from the first storage unit 200 to the image processing ASIC 102.

The second control unit 300 shown in FIG. 11 transmits the image data stored in the second storage unit 400 to the image processing ASIC 102 in the output operation for the image data (for example, printing, processing or transmitting).

The second storage unit 400 shown in FIG. 11 stores image data 4000 which have been acquired in advance.

### <Example of Operation>

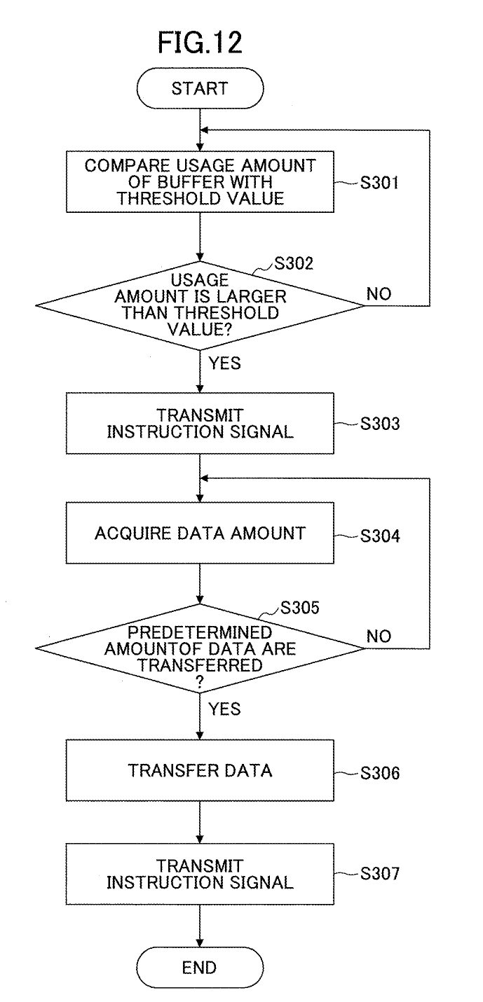

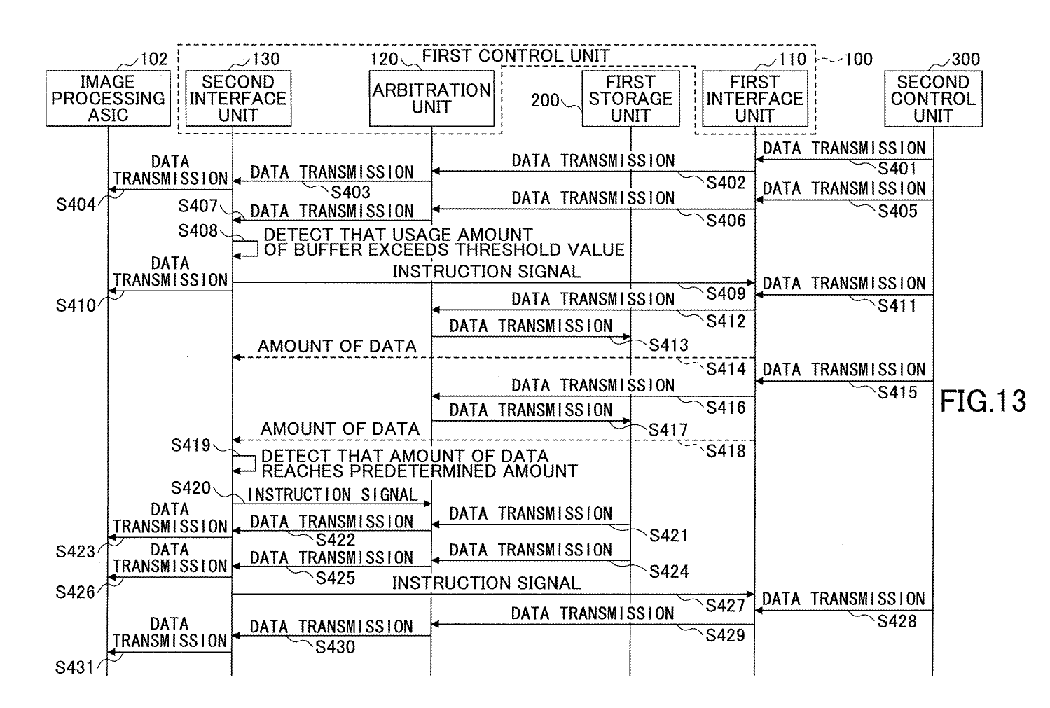

Next, with reference to FIGS. 12 and 13, an example of operation of the image processing apparatus 2 according to the present embodiment will be explained.

FIG. 12 is a flowchart illustrating a flow of processes of the image processing apparatus 2. Here, it is in a state where the second control unit 300 transmits image data in the second storage unit 400 to the image processing ASIC 102.

The monitoring unit 132 in the second interface unit 130 acquires a used amount of a buffer of the transmission/reception unit 131 and compares it with a threshold 1000 (step S301). When the used amount exceeds the threshold 1000 (step S302: YES), the instruction unit 133 transmits an instruction signal to the destination control unit 112 to switch a destination of the image data from the image processing ASIC 102 to the first storage unit 200 (step S303). Otherwise (step S302: NO), the process returns to step S301.

After step S303, the instruction unit 133 acquires a data amount of the transmitted image data via the measurement unit 113 (step S304). When the acquired data amount reaches a predetermined amount (step S305: YES), the instruction unit 133 transmits an instruction signal to the transfer unit 121 to cause the image data stored in the first storage unit 200 to be transferred to the image processing ASIC 102 (step S306). Otherwise (step S305: NO), the process returns to step S304.

After step S306, the instruction unit 133 transmits an instruction signal to the destination control unit 112 to switch the destination of the image data from the first storage unit 200 to the image processing ASIC 102 (step S307).

FIG. 13 is a sequence diagram illustrating an example of an operation of the entire image processing apparatus 2 according to the present embodiment. Here, the second control unit 300 sends an instruction to transmit image data stored in the second storage unit 400 to the image processing ASIC 102.

The second control unit 300 reads image data stored in the second storage unit 400, and transmits the image data to the first control unit 100 (step S401). The first interface unit 110 (transmission/reception unit 131) in the first control unit 100 receives the image data from the second control unit 300, and transmits the image data to the image processing ASIC 102 which is a destination indicated by the destination control unit 112 (step S402). The arbitration unit 120 (transfer unit 121) transmits the image data received from the first interface unit 110 to the second interface unit 130 (step S403). The second interface unit 130 (transmission/reception unit 131) transmits the image data received from the arbitration unit 120 to the image processing ASIC 102 (step S404).

Next, in the same way as above-described steps S401 to S403, image data are transmitted to the second interface unit 130 (steps S405 to 407). Here, assume that data transfer becomes impossible due to a communication error between the image processing ASIC 102 and the first control unit 100, and the used amount of buffer of the transmission/reception unit 131 of the second interface unit 130 becomes greater than the threshold.

The second interface unit 130 (monitoring unit 132) detects that the used amount of the buffer exceeds the threshold (step S408). Then, the second interface unit 130 (instruction unit 133) transmits an instruction signal to the first interface unit 110 (destination control unit 112) to switch the destination of the image data from the image processing ASIC 102 to the first storage unit 200 (step S409). Afterwards, the second interface unit 130 (transmission/reception unit 131) transmits the image data accumulated in the buffer to the image processing ASIC 102 (step S40).

The second control unit 300 further transmits the image data to the image processing ASIC 102 (step S411). The first interface unit 110 (transmission/reception unit 111) receives the image data from the second control unit 300 and transmits the image data to the first storage unit 200 which is a destination indicated by the destination control unit 112 (step S412). The arbitration unit 120 (transfer unit 121) transmits the image data received from the first interface unit 110 to the first storage unit 200 (step S413). The second interface unit 130 (instruction unit 133) receives from the first interface unit 110 (measurement unit 113) a data amount of the transmitted image data (step S414).

Next, in the same way as above-described steps S411 to S414, the image data transmitted from the second control unit 300 are transmitted to the first storage unit 200 and an amount of transmitted data is acquired (step S415 to S418). Here, the second interface unit 130 (instruction unit 133) detects that a data amount of the transmitted image data reaches a predetermined amount (step S419).

Here, the second interface unit 130 (instruction unit 133) transmits an instruction signal to the transfer unit 121 to transfer the image data stored in the first storage unit 200 to the image processing ASIC 102 (step S420). In response to this instruction signal, the arbitration unit 120 (transfer unit 121) receives the image data from the first storage unit 200 (step S421), and transmits the image data to the second interface unit 130 (step S422). The second interface unit 130 (transmission/reception unit 131) transmits the received image data to the image processing ASIC 102 (step S423). Furthermore, in order to transmit all the image data stored in the first storage unit 200 to the image processing ASIC 102, the processes at steps S424 to S426 which are the same as above-described steps S421 to S423 are performed.

After that, the second interface unit 130 (instruction unit 133) transmits an instruction signal to the first interface unit 110 (destination control unit 112) to switch the destination of the image data from the first storage unit 200 to the image processing ASIC 102 (step S427).

Afterwards, in the same way as above-described steps S401 to S404, the image data transmitted from the second control unit 300 are transmitted to the image processing ASIC 102 via the first control unit 100 (step S428 to S431).

According to the above-described operations, in an image output operation in an image processing apparatus, even when an error occurs in a communication path on the side of the image processing ASIC 102, an overflow of a transmission buffer of the second interface unit 130 (PCIe I/F 203) can be prevented. As a result, the image processing apparatus 2 according to the present embodiment can execute an output process without destroying image data. This feature is especially effective when the image processing apparatus 2 outputs a large amount of image data very fast to the image processing ASIC 102.

Further, the present invention is not limited to these embodiments, but various variations and modifications may be made without departing from the scope of the present invention.

The present application is based on and claims the benefit of priority of Japanese Priority Application No. 2013-272519 filed on Dec. 27, 2013, the entire contents of which are hereby incorporated by reference.

What is claimed is:

1. An image reading device comprising:
an arbitration unit;
a first transmission/reception unit that receives read image data and transfers the image data to the arbitration unit;
a second transmission/reception unit that receives the image data from the arbitration unit and transfers the image data to a first storage unit;
a detection unit that detects that a used amount of a buffer of the second transmission/reception unit exceeds a threshold; and
an instruction unit that instructs changing a destination of image data, which are to be transferred from the first transmission/reception unit, to a second storage unit which is connected to the arbitration unit in response to a detection by the detection unit that the used amount of the buffer exceeds the threshold.

2. The image reading device as claimed in claim 1, wherein the instruction unit is further configured to send an instruction to change the destination of the image data, which are to be transferred from the first transmission/reception unit, to the second transmission/reception unit in response to a data amount of the image data transferred to the second storage unit reaching to a predetermined amount.

3. The image reading device as claimed in claim 2, wherein the arbitration unit transfers the image data stored in the second storage unit to the second transmission/reception unit in response to a change of the destination of the image data, which are to be transferred from the first transmission/reception unit, to the second transmission/reception unit.

4. The image reading device as claimed in claim 1, further comprising:
a first control unit and a second control unit, wherein the first control unit is connected to the first storage unit and the second control unit, and the second control unit is connected to the first control unit.

5. The image reading device as claimed in claim 4, wherein the first storage unit is a main memory which is faster than the second storage unit.

6. The image reading device as claimed in claim 5, wherein the second storage unit is a SD (Secure Digital) card.

7. The image reading device as claimed in claim 5, wherein the second storage unit is a storage device connected via a network.

8. The image reading device as claimed in claim 5, wherein the arbitration unit and the second storage unit are connected to each other via a NAND memory interface.

9. The image reading device as claimed in claim 5, wherein the arbitration unit and the second storage unit are connected to each other via an SPI (Serial Peripheral Interface).

10. An image reading method comprising:
receiving read image data by a first transmission/reception unit;
transferring the image data received by the first transmission/reception unit to an arbitration unit;
receiving the image data by a second transmission/reception unit from the arbitration unit;
transferring the image data received by the second transmission/reception unit to a first storage unit;
detecting that a used amount of a buffer of the second transmission/reception unit exceeds a threshold; and
instructing to change a destination of image data, which are to be transferred from the first transmission/reception unit, to a second storage unit which is connected to the arbitration unit in response to a detection that the used amount of the buffer exceeds the threshold.

11. A non-transitory computer-readable storage medium storing a program for causing a computer to execute an image reading method, the image reading method comprising:
a step of receiving read image data by a first transmission/reception unit;
a step of transferring the image data received by the first transmission/reception unit to an arbitration unit;
a step of receiving the image data by a second transmission/reception unit from the arbitration unit;
a step of transferring the image data received by the second transmission/reception unit to a first storage unit;
a step of detecting that a used amount of a buffer of the second transmission/reception unit exceeds a threshold; and
a step of instructing to change a destination of image data, which are to be transferred from the first transmission/reception unit, to a second storage unit which is connected to the arbitration unit in response to a detection that the used amount of the buffer exceeds the threshold.
